(19) United States
(12) Patent Application Publication
(10) Pub. No.: US 2011/0075979 A1
(43) Pub. Date: Mar. 31, 2011

(54) ARMORED OPTICAL FIBER CABLE

(75) Inventors: Chung-Shin Ma, Morganville, NJ (US); Ralph J. Rue, Jackson, NJ (US); Alfred I. Quigley, JR., South Amboy, NJ (US)

(73) Assignee: TYCO TELECOMMUNICATIONS (US) INC., Morristown, NJ (US)

(21) Appl. No.: 12/031,862

(22) Filed: Feb. 15, 2008

Related U.S. Application Data
(63) Continuation of application No. PCT/US06/31711, filed on Aug. 15, 2006.
(60) Provisional application No. 60/708,193, filed on Aug. 15, 2005.

(51) Int. Cl. G02B 6/44

(52) U.S. Cl. 385/107

(57) ABSTRACT

An armored optical fiber cable may include a core cable portion and an armored cable portion surrounding the core cable portion. The core cable portion may include, among other layers, a steel tape layer wrapped around an insulation layer surrounding a conductive sheath. The steel tape layer improves armored resistance to dragging and abrasion caused by fishing gear by protecting the insulation layer surrounding the sheath.

### CROSS-REFERENCE TO RELATED APPLICATIONS

This application is a U.S. continuation of International Application No. PCT/US06/31711 filed Aug. 15, 2006, which claims the benefit of U.S. Provisional Patent Application Ser. No. 60/708,193, filed on Aug. 15, 2005, all of which are incorporated herein by reference.

### TECHNICAL FIELD

The present invention relates to optical fiber cables and more particularly, to an armored optical fiber cable suitable for enhanced fishing gear protection.

### BACKGROUND INFORMATION

Optical fiber cables have been designed for use in an undersea environment, for example, to carry optical signals in a long-haul optical communication system. Because of the fragile nature of the optical fibers in these cables, the cables include layers to protect the optical fibers from external forces. Different types of optical fiber cables (i.e., with different arrangements of protective components or layers) may be used depending upon the undersea environment and the risk of damage to the cable. In shallow water close to shore, for example, there is a risk of damage from fishing gear. In deep water, on the other hand, the risk of damage from fishing gear may be minimal but the risk of damage caused by shark bites may be higher. The nature of the terrain in the undersea environment (e.g., a rocky bottom versus a sandy bottom) may also be a factor in the cable design.

Existing optical fiber cables include a light weight (LW) cable type designed for deep water and sandy bottoms; a special application (SPA) cable type designed to withstand shark bites; and armored cable types designed for rocky terrain and to withstand dragging. Because the SPA cable is designed for deep water, this cable is not usually subject to dragging by fishing gear and may not be suitable to withstand such forces. Existing armored cables may provide better protection from the dragging and abrasion of fishing gear but the protection may be limited due to the loose nature of the armor components.

### BRIEF DESCRIPTION OF THE DRAWINGS

These and other features and advantages will be better understood by reading the following detailed description, taken together with the drawings wherein:

FIG. 1 is a partial cutaway perspective view of an optical fiber cable, consistent with one embodiment of the present invention.

### DETAILED DESCRIPTION

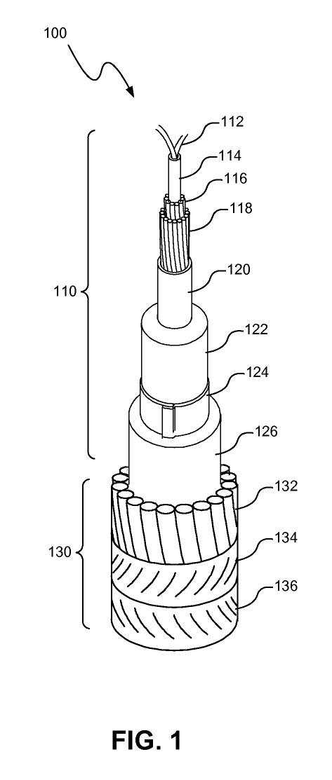

Referring to FIG. 1, an armored optical fiber cable 100, consistent with one embodiment of the present invention, may be used to carry optical signals through an undersea environment. One or more sections of the armored cable 100 may be coupled together to form an optical communication system, such as a long-haul optical communication system. The armored optical fiber cable 100 generally includes a core cable portion 110 and an armored cable portion 130 surrounding the core cable portion 110. As will be described in greater detail below, the core cable portion 110 may be designed to provide added protection against the dragging and abrasion of fishing gear or other similar loads. Although the armored optical fiber cable 100 is designed for use in an undersea environment, the armored optical fiber cable 100 may also be used in terrestrial applications.

The core cable portion 110 may include optical fibers 112 surrounded by a tube 114 and one or more wire layers 116, 118. The optical fibers 112 may include any type of optical fibers capable of carrying optical signals and providing suitable dispersion characteristics, as is known to those skilled in the art. The tube 114 may be made of a polymer such as polycarbonate or polyamide, or a metal such as stainless steel, copper, or aluminum. The tube 114 may also include a gel, such as a thixotropic, water-blockable gel, surrounding the optical fibers 112. The wire layers 116, 118 may include first and second layers 116, 118 of high strength steel wires with water-blocking material in the interstices between the wires. In one embodiment, a first layer 116 may include eight (8) wires and a second layer 118 may include eight (8) wires of one diameter circumferentially alternating with eight (8) wires of a smaller diameter. The wires 116, 118 may have diameters in a range of about 1 mm to 2 mm.

The core cable portion 110 may also include a conductive sheath 120 around the wire layers 116, 118 and a first insulation layer 122 around the conductive sheath 120. The sheath 120 may be made of a conductive material such as copper. The conductive sheath 120 may serve as both an electrical conductor within the cable 100 and a hermetic barrier. The first insulation layer 122 may include a medium density or high density polyethylene jacket that encapsulates and insulates the conductive sheath 120. In one embodiment, the first insulation layer 122 may have a thickness in a range of about 4 mm to 6 mm.

The core cable portion 110 may further include one or more steel tape layers 124 wrapped around the first insulation layer 122 and a second insulation layer 126 around the steel tape layer(s) 124. The steel tape layer(s) 124 may be an adhesive-coated steel tape layer longitudinally wrapped around the first insulation layer 122. One example of an adhesive-coated steel tape may include Zetabon FOS262 available from Dow Chemical. The second insulation 126 layer may include a high density polyethylene jacket that encapsulates and insulates the steel tape layer(s) 124. In one embodiment, the second insulation layer 126 may have a thickness in a range of about 1 mm to 6 mm providing an outer diameter in a range of about 14 mm to 32 mm.

The armored cable portion 130 may include one or more layers of armor wire strength members 132 around the second insulation layer 126 and one or more binder layers 134, 136 around the strength members 132. The armor wire strength members 132 may include tar-covered galvanized wires. In one embodiment, the wire strength members 132 may have an outer diameter in a range of about 0.1 mm to 5 mm. The binder layers 134, 136 may include first and second layers 134, 136 of tar-soaked nylon yarn. In one embodiment, the outer diameter of the optical fiber cable 100 may be in the range of 25 mm to 60 mm.

In the armored optical fiber cable 100, the steel tape layer(s) 124 may advantageously protect the inner portion of the cable core portion 110 (i.e., the first insulation layer 122, the conductive sheath 120, the tube 114 and the optical fibers 112) against damage caused by penetration of the armor wire strength members 132 when the cable is dragged by fishing gear. Without the steel tape layer(s) 124, the insulation layer 122 and the conductive sheath 120 are more vulnerable because dragging by fishing gear may cause the cable to bend and the wire strength members 132 to penetrate the first insulation layer 122 and the conductive sheath 120.

Consistent with one embodiment of the present invention, an armored optical fiber cable includes a core cable portion and an armored cable portion around the core cable portion. The core cable portion includes a plurality of optical fibers, a tube around the optical fibers, at least one layer of wires around the tube, a conductive sheath around the wires, a first insulation layer around the conductive sheath, at least one steel tape layer wrapped around the first insulation layer, and a second insulation layer around the steel tape layer. The armored cable portion including at least one layer of armor wire strength members and at least one binder layer around the armor wire strength members.

Consistent with another embodiment of the present invention, an armored optical fiber cable includes a core cable portion and an armored cable portion around the core cable portion. The core cable portion includes a plurality of optical fibers, a polymer tube around the optical fibers, first and second layers of steel wires around the polymer tube, a copper sheath around the second layer of steel wires, a medium density polyethylene jacket around the copper sheath, at least one adhesive-coated steel tape longitudinally wrapped around the medium density polyethylene jacket, and a high density polyethylene jacket around the adhesive-coated steel tape. The armored cable portion including at least one layer of tar-covered galvanized wires and at least one layer of tar-soaked nylon yarn around the tar-covered galvanized wires.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An armored optical fiber cable comprising:
a core cable portion including a plurality of optical fibers, a tube around the optical fibers, at least one layer of wires around the tube, a conductive sheath around the wires, a first insulation layer around the conductive sheath, at least one steel tape layer wrapped around the first insulation layer, and a second insulation layer around the steel tape layer; and
an armored cable portion around the core cable portion, the armored cable portion including at least one layer of armor wire strength members and at least one binder layer around the wire strength members.

2. The armored optical fiber cable of claim 1 wherein the steel tape layer is an adhesive-coated steel tape.

3. The armored optical fiber cable of claim 1 wherein the steel tape layer is longitudinally wrapped around the insulation layer.

4. The armored optical fiber cable of claim 1 wherein the tube is a polymer tube.

5. The armored optical fiber cable of claim 1 wherein the at least one layer of wires around the tube includes first and second layers of wires.

6. The armored optical fiber cable of claim 5 wherein the first and second layers of wires include steel wires.

7. The armored optical fiber cable of claim 1 wherein the conductive sheath around the wires is a copper sheath.

8. The armored optical fiber cable of claim 1 wherein the first insulation layer around the conductive sheath includes a medium density polyethylene.

9. The armored optical fiber cable of claim 1 wherein the second insulation layer around the steel tape layer includes a high density polyethylene.

10. The armored optical fiber cable of claim 1 wherein the at least one layer of armor wire strength members include tar-covered galvanized wires.

11. The armored optical fiber cable of claim 1 wherein the at least one binder layer includes at least one layer of tar-soaked nylon yarn.

12. The armored optical fiber cable of claim 1 wherein the at least one binder layer includes at least first and second binder layers.

13. An armored optical fiber cable comprising:
a core cable portion including a plurality of optical fibers, a polymer tube around the optical fibers, first and second layers of steel wires around the polymer tube, a copper sheath around the second layer of steel wires, a medium density polyethylene jacket around the copper sheath, at least one adhesive-coated steel tape longitudinally wrapped around the medium density polyethylene jacket, and a high density polyethylene jacket around the adhesive-coated steel tape; and
an armored cable portion around the core cable portion, the armored cable portion including at least one layer of tar-covered galvanized wires and at least one layer of tar-soaked nylon yarn around the tar-covered galvanized wires.
